(19) United States
(12) Patent Application Publication
(10) Pub. No.: US 2022/0005018 A1
(43) Pub. Date: Jan. 6, 2022

(54) Systems and Methods for Communicating Transaction Information Between Electronic Devices

(71) Applicant: Gelliner Limited, Douglas, Isle of Man (GB)

(72) Inventors: Brett Andrew White, Cape Town (ZA); David de Villiers, Ballito (ZA)

(21) Appl. No.: 17/288,888

(22) PCT Filed: Oct. 17, 2019
(86) PCT No.: PCT/GB2019/052976

§ 371 Date: Apr. 26, 2021

(30) Foreign Application Priority Data
Nov. 1, 2018 (GB) 1817881.4

(51) Int. Cl. G06Q 20/32; G06Q 20/20

(52) U.S. Cl. CPC G06Q 20/3224; G06Q 20/3223; G06Q 20/204; G06Q 20/202; G06Q 20/3278

(57) ABSTRACT

An application server may receive, from a computing device, transaction information relating to a transaction to be completed at a location, with the transaction information including a first identifier of the location. The application server may also receive, from a mobile device, a request for information relating to the transaction, with the request including a second identifier of the location. The application server may determine an association between the transaction information and the request based on the first identifier and the second identifier. Based on the determined association and responsive to the request, the application server may transmit, to the mobile device, at least part of the transaction information. The application server may receive, from the mobile device, an instruction to complete the transaction and, responsive to receiving the instruction, attempt completion of the transaction using the transaction information and transaction credentials associated with the mobile device.

### FIELD

The present disclosure relates generally to payment processing, and more particularly, to systems and methods for processing of payment for goods and services at a point of sale using a mobile device of a user.

### BACKGROUND

A quick response (QR) code is a two-dimensional barcode. Some merchants utilize QR codes to facilitate payment for goods and/or services.

In a first QR-code based implementation, a single, static QR code can encode information that identifies a particular merchant. The static QR code may be displayed (e.g., on a sign) at a point-of-sale (POS), and remain the same for multiple transactions completed at the POS. To initiate payment to the merchant, a customer (or user) can scan the QR code with a mobile device, such as a smartphone. The mobile device may include an application that decrypts the information encoded in the QR code so as to reveal an identifier of the merchant. After scanning the QR code, the customer can enter, on the mobile device, a payment amount to be paid to the merchant, and send an instruction to an application server to process the payment. The application server, in turn, can attempt to process payment for the goods or services using payment credentials associated with the customer. After attempting to process the payment, the application server can notify the customer and the merchant regarding whether or not the payment was successfully processed.

When static QR codes are used, problems can arise due to operator or user error. For instance, the customer could incorrectly enter the payment amount for the goods and/or services on the mobile device. Also, the merchant might be unaware of the payment amount entered by the customer until after the payment is processed, and may review a notification received from the application server after the transaction is completed to verify that the customer entered the proper payment amount. This review is prone to operator error, and could also take an undesirably long time, leading to a poor customer experience.

In a second QR-code based implementation, a merchant's POS device may be associated with a QR code generator which can dynamically generate a QR code (i.e. a dynamic QR code) with details of the payment to be made, such as the payment amount and possibly specific details of the individual goods or services to be purchased. Such a generated QR code may be displayed to a customer at the POS. Like in the first QR-code based implementation, the customer may scan the QR code using a mobile device, and an application on the mobile device can decrypt information encoded in the QR code. However, unlike in the first QR-code based implementation, the information encoded in the QR code can include the payment amount and details specific to the transaction (e.g., a list of items to be purchased). After obtaining approval from the customer, the application on the mobile device can send an instruction to an application server to process the payment.

In the second QR-code based implementation, inclusion of the payment amount in the QR code itself can limit the risk of user error. Further, inclusion of the list of items in the QR code can allow the customer to check the list for errors. However, because the QR codes vary from transaction to transaction, the QR codes are generated at the time of the transaction and then provided to the customer. For instance, the QR code can be printed on an invoice or provided on a digital display.

In some situations, it could be undesirable to generate a dynamic QR code and provide the QR code to a user at a POS. At a POS of a grocery store, for example, an invoice is normally only printed after successful payment. Printing individual QR codes for each transaction may be time-consuming and may also be undesirable due to environmental concerns associated with the paper printing process. While providing the QR codes on a digital display could solve the environmental concerns and eliminate the need for paper printing, the expenses associated with installing and maintaining a digital display could be undesirable, particularly for a merchant with multiple points-of-sale, such as a large grocery store.

### SUMMARY

Aspects and preferred features are set out in the accompanying claims.

Viewed from one aspect, the disclosure provides a computer-implemented method. The method includes receiving, by an application server from a computing device, transaction information relating to a transaction to be completed at a location, with the transaction information including a first identifier of the location. The method also includes receiving, by the application server from a mobile device, a request for information relating to the transaction, with the request including a second identifier of the location. Additionally, the method includes determining, by the application server, an association between the transaction information relating to the transaction and the request for information relating to the transaction based on the first identifier of the location and the second identifier of the location. Further, the method includes based on the determined association and responsive to the request for information relating to the transaction, transmitting, by the application server to the mobile device, at least part of the transaction information relating to the transaction. Still further, the method includes receiving, by the application server from the mobile device, an instruction to complete the transaction. Still further, the method includes responsive to receiving the instruction, attempting, by the application server, completion of the transaction using the transaction information and transaction credentials associated with the mobile device.

Viewed from a second aspect, the disclosure provides a computer-implemented method that includes retrieving, by a mobile device at a location of a transaction to be completed, a location identifier associated with the location. The method also includes transmitting, by the mobile device to an application server, a request for information relating to the transaction, with the request including the location identifier. Additionally, the method includes responsive to the transmitting of the request, receiving, by the mobile device, transaction information relating to the transaction. Further, the method includes providing, by the mobile device for display, at least part of the transaction information. Still further, the method includes obtaining, by the mobile device by way of a user interface of the mobile device, an approval of the transaction and, responsive to obtaining the approval, transmitting, by the mobile device to the application server, an instruction to complete the transaction.

Viewed from a third aspect, the disclosure provides a computer-implemented method that includes receiving, by a server device from a computing device that is located at a location of a transaction to be completed using a mobile device at the location, transaction information relating to the transaction. The method also includes transmitting, by the server device to an application server, the transaction information relating to the transaction and a first identifier of the location. The application server is configured to determine an association between the transaction information relating to the transaction and a request for information relating to the transaction based on the first identifier of the location and a second identifier of the location that is retrieved by the mobile device at the location. Additionally, the method includes receiving, by the server device from the application server, a transaction message indicating whether the transaction was successful or unsuccessful. Further, the method includes transmitting, by the server device to the computing device, the transaction message.

In a fourth aspect, an article of manufacture may include a non-transitory computer-readable medium, having stored thereon program instructions, that upon execution by a processor, cause a computing device to perform the operations of any of the first, second, or third aspects.

In a fifth aspect, a computing device may include a processor, a memory component, and program instructions, stored in the memory, that upon execution by the processor, cause the computing device to perform the operations of any of the first, second, or third aspects.

In a sixth aspect, a system may include various means for carrying out the operations of any of the first, second, or third aspects.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

Some preferred embodiments of the disclosure will now be described by way of example only and with reference to the accompanying drawings, in which:

FIG. 1 is a schematic representation of a system for processing payment, in accordance with example embodiments.

FIG. 2 is a simplified block diagram of an example application server, in accordance with example embodiments.

FIG. 3 is a simplified block diagram of an example mobile device, in accordance with example embodiments.

FIG. 4 is a simplified block diagram of an example merchant server, in accordance with example embodiments.

FIG. 5 is a simplified block diagram of an example point-of-sale device, in accordance with example embodiments.

FIGS. 6A, 6B, and 6C are a swim-lane flow diagram, in accordance with example embodiments.

FIG. 7 is a flow chart, in accordance with example embodiments.

FIG. 8 is another flow chart, in accordance with example embodiments.

FIG. 9 is yet another flow chart, in accordance with example embodiments.

### DETAILED DESCRIPTION

### I. Introduction

This description describes, among other things, several example embodiments including, but not limited to, example embodiments pertaining to processing a transaction at a location using a mobile device.

By way of example, while at the location, a user may choose to pay for a transaction via their mobile device, possibly via a specific application installed thereon and facilitating use of the systems and methods of the present application. To facilitate this payment process, a computing device may transmit, to an application server, transaction information relating to a transaction to be completed at the location. The transaction information includes a first identifier of the location. The first identifier can be a static identifier of the location. The computing device could be located at the location. For instance, the computing device could be a POS device located at the location. Alternatively, the computing device could be a server device that is in data communication with a POS device located at the location.

At the same time, the mobile device can capture an encrypted version of a second identifier of the location that is provided at the location, decrypt the encrypted version, and transmit a request for information relating to the transaction to the application server. The request includes the second identifier of the location. The second identifier can be a static identifier of the location. The mobile device can capture the encrypted version from a barcode, such as a QR code. Alternatively, the mobile device can capture the encrypted version from a radio frequency identification (RFID) tag, such as a near-field communication (NFC) tag.

The application server, in turn, can determine an association between the transaction information relating to the transaction (received from the computing device) and the request for information relating to the transaction (received from the mobile device) based on the first identifier of the location and the second identifier of the location. For instance, the application server can match the first identifier of the location and the second identifier of the location. Based on the determined association and responsive to the request for information relating to the transaction, the application server can transmit to the mobile device at least part of the transaction information relating to the transaction.

On the mobile device, the user can view the at least part of the transaction information and initiate payment for the transaction if so desired. The user may instruct the application server to cancel the current transaction, or may instruct it to process payment therefor, thereby to successfully complete the transaction. The mobile device may send payment credentials stored on the mobile device to the application server, or the application server can retrieve the payment credentials from a secure database. It should be noted that the payment credentials may be stored in any suitable encrypted format. The application server may then communicate with a financial institution, typically an issuing bank, to process payment for the transaction. The application server may communicate with the issuing bank via an acquiring bank.

Once payment for the transaction has been completed, the application server may inform the computing device of the success, or not, therefor. For example, the computing device can be a merchant server, and the merchant server can in turn inform a POS device at the location, so that an operator may act on such completed transaction as appropriate. The application server can also inform the mobile device regarding whether payment for the transaction was successful or unsuccessful.

Advantageously, the systems and methods disclosed herein can address the problems of the QR-code based implementations mentioned above. For instance, unlike the first QR-based implementation, with the systems and methods disclosed herein, the user might not need to enter the payment amount for a transaction, since the transaction information that the application server provides to the mobile device can include the payment amount. In other words, the systems and methods disclosed herein can eliminate an opportunity for the user to enter an incorrect payment amount.

Further, unlike the first QR-based implementation, with the systems and methods disclosed herein, the user of the mobile device can also have an opportunity to review transaction information on the mobile device. For instance, the user can review a list of goods and/or services on a display of the mobile device. Hence, the systems and methods disclosed herein provide one of the same benefits that the second QR-code based implementation provides, but without requiring use of dynamic QR codes.

Still further, unlike the second QR-code based implementation, the systems and methods disclosed herein can be implemented without requiring generation and display of dynamic QR codes. For instance, rather than printing dynamic QR codes on invoices or providing dynamic QR codes for display on a digital display, a merchant can provide a static QR code at a POS. In other words, the systems and methods disclosed herein can eliminate any unnecessary printing and/or the need to install and maintain a digital display for displaying dynamic QR codes. The systems and methods disclosed herein also eliminate the need to provide a QR code generator at the POS, thereby reducing the amount of computer processing required at the POS. As such, the systems and methods disclosed herein can be implemented more cost-effectively by a merchant than the second QR-code based implementation.

To help illustrate features of the present disclosure, portions of this disclosure focus on QR codes by way of example. Those of ordinary skill in the art will readily appreciate, however, that the disclosed principles can be applied as well using other types of encrypted information, such as other types of barcodes or RFID tags, with variations where appropriate.

In this description the terms “user” and “customer” are used interchangeably depending on the context. For example a user of an application on a mobile device can also be a customer of a merchant.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” with a described list of at least two terms is to indicate any of the listed terms or any combination of the listed terms.

The use of ordinal numbers such as “first,” “second,” “third,” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### II. Example Architecture

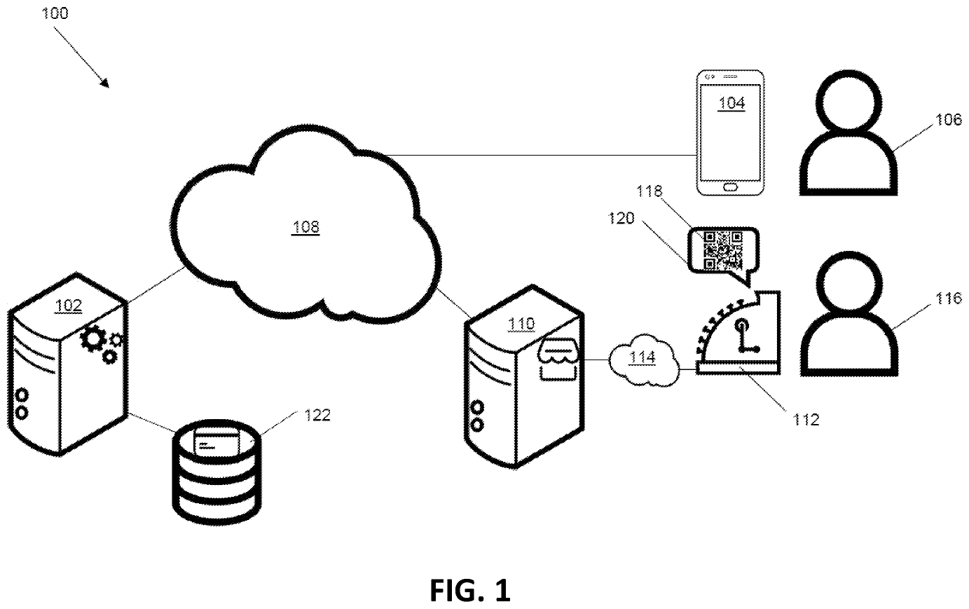

Referring now to FIG. 1 depicts a schematic representation of an example system 100 for processing payment, in accordance with example embodiments described herein. The system 100 includes an application server 102 in data communication with a mobile device 104 of a user 106 via a communication network 108. The communication network 108 can include a wide-area network, such as the Internet. A merchant server 110 is also in data communication with the application server 102 over the communication network 108. The merchant server 110 is in data communication with a POS device 112, also over a communication network 114. The communication network 114 can include a wide-area network, such as the Internet. The communication network 114 can also include a communication network associated with only a specific merchant, such as an intranet. FIG. 1 depicts the POS device 112 as being operated by an operator 116, such as a cashier. Alternatively, the POS device 112 can be a self-checkout device that can be operated by user 106.

A unique identifier of a location at which a transaction is to be completed is provided at the location. As shown in FIG. 1, the identifier can be an encrypted version of the unique identifier, such as a two-dimensional barcode in the form of a QR code 118. The unique identifier can include an identifier of a location of the merchant. Optionally, the unique identifier can include an identifier of one of a plurality of points-of-sale at the merchant, such as an identifier of POS device 112. The QR code 118 can be printed on a sign 120 that is located at the location.

The mobile device 104 can be any type of mobile device, such as a smartphone, tablet, or wearable computing device. Further, the mobile device 104 can have an application installed thereon which facilitates operation of the system and methods associated therewith. The application may be configured to establish a secure communication channel with the application server 102. The mobile device 104 can be registered for use of the system 100. At a time of registering for use of the system 100, the user 106 can provide at least one set of payment credentials, for example credit card details, to the application server 102 over the communication network 108.

The application server 102 can store the payment credentials in a database 122 associated with the application server 102. The payment credentials may be stored in an encrypted, tokenized format, and may only be decrypted when needed for processing payment. The database 122 may be expected to comply with payment card industry data security standards, and may be operated and managed by a third party. If operated by a third party, communication between the database 122 and the application server 102 may take place via a server of the third party. The application server 102 can retrieve the payment credentials from the database 122 when required for processing payment.

The application server 102 may be any appropriate computing device performing the role of a server, such as a server computer, distributed server computer, cloud-based server computer, server computer cluster, or the like. Similarly, the merchant server 110 may be any appropriate computing device performing the role of a server, such as a server computer, distributed server computer, cloud-based server computer, server computer cluster, or the like.

While only one POS is shown in the system 100 of FIG. 1, the system 100 may include a plurality of points-of-sale, possibly located at multiple different merchants. When multiple points-of-sale are included, each such POS can have a unique identifier so that a transaction may be linked to a respective POS at which a user is attempting to transaction with a mobile device.

The mobile device 104 can be generally under the exclusive control of the user 106. Payment credentials that the user 106 provides to the mobile device 104 for storage in the database 122 may therefore be uniquely associated with the mobile device 104, and each time that that mobile device 104 is used to communicate with the application server 102, the application server may rely on an assumption that the user 106 is operating the mobile device 104.

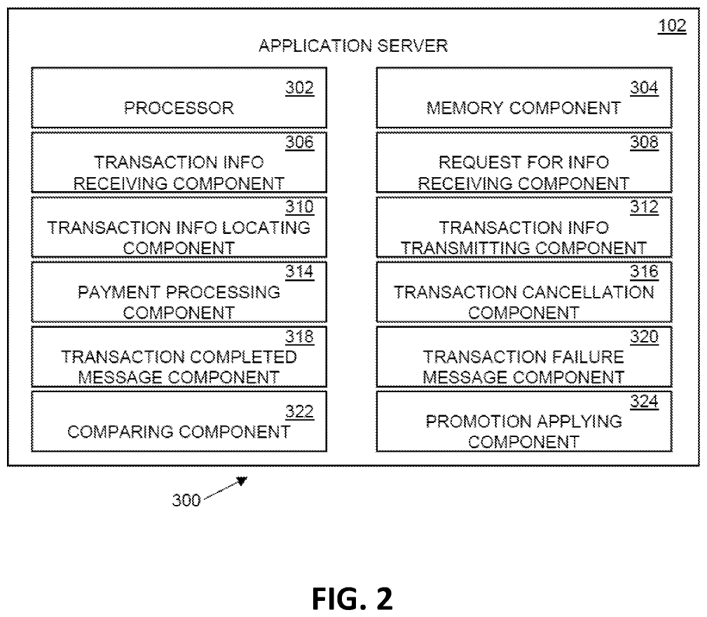

Next, FIG. 2 is a block diagram 300 depicting an example embodiment of the application server 102. In line with the discussion above, the application server 102 may be arranged to implement any of the methods for processing payment described herein. As shown in FIG. 2, the application server 102 may include a processor 302 arranged to execute the functions of various components, which may be provided by hardware or by software units executing on the application server 102. The software units may be stored in a memory component 304, and instructions may be provided to the processor 302 to carry out the functionality of the described components. The various components can include a transaction information receiving component 306, a requesting for information receiving component 308, a transaction information location component 310, a transaction information transmitting component 312, a payment processing component 314, a transaction cancellation component 316, a transaction completed message component 318, a transaction failure message component 320, a comparing component 322, and a promotion applying component 324.

The transaction information receiving component 306 may be arranged to receive transaction information relating to a transaction to be completed from a server device registered for use of a system, such as merchant server 110 of FIG. 1. The transaction information may include a first identifier of a location, such as a first POS identifier.

The request for information receiving component 308 may be arranged to receive a request for information relating to a transaction from a mobile device registered for use of the system, such as mobile device 104 of FIG. 1. The request for information may include a second identifier of the location retrieved by the mobile device at the location, such as a second POS identifier retrieved by the mobile device.

The transaction information locating component 310 may be arranged to locate transaction information associated with the request for information. This may be done by determining an association between transaction information and a request for information based on the first identifier and the second identifier. For instance, the transaction information locating component 310 may be arranged to match the second identifier to transaction information received with a matching, first identifier. Based on the matching, the transaction information locating component 310 can link the transaction information to the mobile device from which the second identifier was received.

The transaction information transmitting component 312 may be arranged to transmit, to the mobile device, at least a part of the transaction information received from the server device. The payment processing component 314 may be arranged to process payment for the transaction in response to receiving a payment processing instruction from the mobile device for the transaction. Payment may be processed using payment credentials associated with the mobile device. A payment credential receiving component may also form part of the application server 102 and may be arranged to receive payment credentials from the mobile device or from a database associated with the application server 102, such as database 122 of FIG. 1. Conversely, the transaction cancellation component 316 may be arranged to cancel a transaction in response to receiving a payment cancellation instruction from the mobile device.

The transaction completed message component 318 may be arranged to, responsive to successfully processing payment, transmit a transaction completed message to the mobile device and/or the server device. Conversely, the transaction failure message component 320 may be arranged to, responsive to unsuccessfully processing payment, transmit a transaction failure message to the mobile device and/or the server device.

The comparing component 322 may be arranged to compare received transaction information with details of an existing promotion. The promotion applying component 324 may be arranged to apply a promotion to the current transaction if the comparing component 322 detects that a specific promotion is applicable to the current transaction. After the promotion has been applied, the transaction information transmitting component 312 may transmit the transaction information to the mobile device.

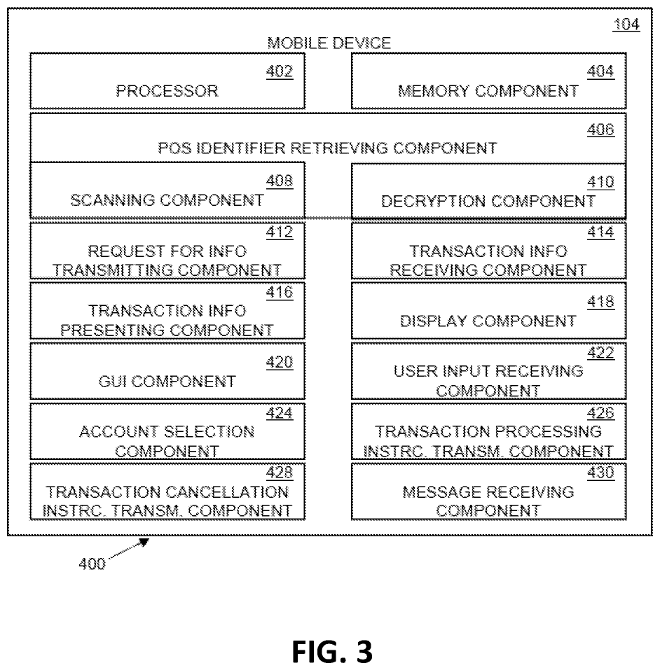

Next, FIG. 3 is a block diagram 400 depicting an example embodiment of the mobile device 104 of FIG. 1. In line with the discussion above, the mobile device 104 may be arranged to implement any of the methods for processing payment described herein. As shown in FIG. 3, the mobile device 104 may include a processor 402 arranged to execute the functions of various components, which may be provided by hardware or by software units executing on the mobile device 104. The software units may be stored in a memory component 404, and instructions may be provided to the processor 402 to carry out the functionality of the described components. The various components can include a POS identifier retrieving component 406, a request for information transmitting component 412, a transaction information receiving component 414, a transaction information presenting component 416, a display component 418, a graphical user interface (GUI) component 420, a user input receiving component 422, an account selection component 424, a transaction processing instruction transmitting component 426, a transaction cancellation instruction transmitting component 428, and a message receiving component 430.

The POS identifier retrieving component 406 may be arranged to retrieve a location identifier at a POS of a merchant. To enable this, the POS identifier retrieving component 406 can include a scanning component 408 and a decryption component 410. The scanning component 408 may include a camera that is arranged to capture an encrypted version of the location identifier from a barcode. Additionally or alternatively, the scanning component 408 may include an RFID reader that is arranged to capture an encrypted version of the location identifier from an RFID tag. The decryption component 410 may be arranged to decrypt the encrypted version of the location identifier so as to reveal the location identifier.

The request for information transmitting component 412 may be arranged to transmit a request for information relating to a transaction at the location to an application server, such as application server 102 of FIG. 1. The request for information may include the location identifier retrieved at the location.

The transaction information receiving component 414 may be arranged to receive transaction information relating to the transaction. The transaction information presenting component 416 may be arranged to present a user with the received transaction information on a display associated with the mobile device 104. The display component 418 may be arranged to display the transaction information. The display component 418 may be a touch-sensitive display, for instance. The GUI component 420 may be arranged to provide a GUI on the display component 418.

The user input receiving component 422 may be arranged to receive an instruction in the form of user input to process or cancel payment for the transaction. User input may be received via the GUI component 420, for example.

The account selection component 424 may be arranged to provide the user with a selection of accounts from which payment may be made. Hence, the user input receiving component 422 may be further arranged and configured to receive user input indicating which of the accounts should be used to process payment.

The transaction processing instruction transmitting component 426 may be arranged to transmit a payment processing instruction to the application server responsive to the user providing the appropriate input to process payment. Whereas, the transaction cancellation instructing transmitting component 428 may be arranged to transmit a payment cancellation instruction to the application server responsive to the user providing an instruction to cancel the transaction. The message receiving component 430 may be arranged to receive a transaction successful or a transaction unsuccessful message.

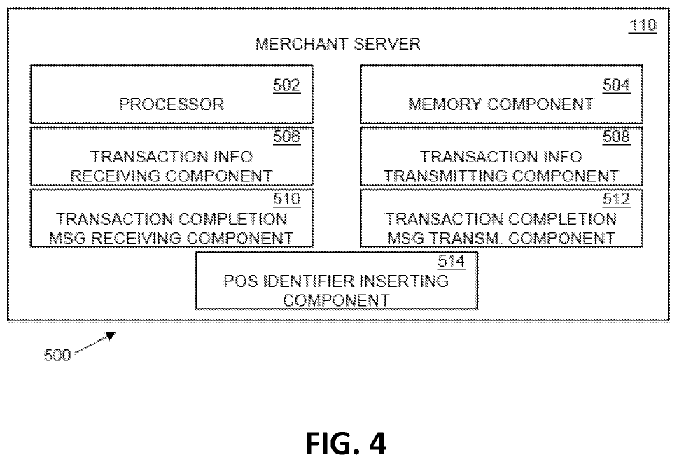

Next, FIG. 4 is a block diagram 500 depicting an example embodiment of the merchant server 110 of FIG. 1. In line with the discussion above, the merchant server 110 may be arranged to implement any of the methods for processing payment described herein. As shown in FIG. 4, the merchant server 110 may include a processor 502 arranged to execute the functions of various components, which may be provided by hardware or by software units executing on the merchant server 110. The software units may be stored in a memory component 504, and instructions may be provided to the processor 502 to carry out the functionality of the described components. The various components can include a transaction information receiving component 506, a transaction information transmitting component 508, a transaction completion message receiving component 510, a transaction completion message transmitting component 512, and a POS identifier inserting component 514.

The transaction information receiving component 506 may be arranged to receive transaction information relating to a transaction to be completed at a location, such as transaction information relating to a transaction to be completed at a POS device associated with merchant server 110. The transaction information transmitting component 508 may be arranged to transmit the transaction information, including a location identifier indicating where the transaction originates from, to an application server, such as the application server 102 of FIG. 1.

The transaction completion message receiving component 510 may be arranged to receive a transaction completion message indicating whether the transaction was successful or unsuccessful from the application server. The transaction completion message transmitting component 512 may be arranged to transmit the transaction completion message to a computing device at the location, such as POS device 112 of FIG. 1.

The POS identifier inserting component 514 may be arranged to insert the location identifier into the transaction information before the transaction information transmitting component 508 transmits the transaction information to the application server. For instance, the POS identifier inserting component 514 can determine a location identifier corresponding to a computing device that transmitted the transaction information to the server device, and output the location identifier so that the transaction information transmitting component 508 can transmit the location identifier to the application server.

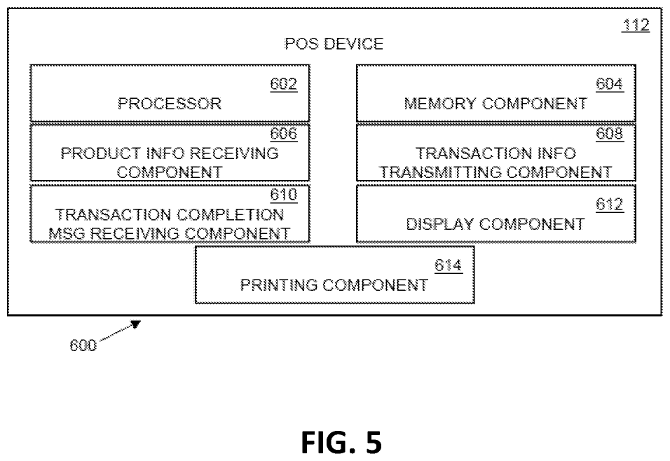

Next, FIG. 5 is a block diagram 600 depicting an example embodiment of the POS device 112 of FIG. 1. In line with the discussion above, the POS device 112 may be arranged to implement any of the methods for processing payment described herein. As shown in FIG. 5, the POS device 112 may include a processor 602 arranged to execute the functions of various components, which may be provided by hardware or by software units executing on the POS device 112. The software units may be stored in a memory component 604, and instructions may be provided to the processor 602 to carry out the functionality of the described components. The various components can include a product information receiving component 606, a transaction information transmitting component 608, a transaction completion message receiving component 610, a display component 612, and a printing component 614.

The product information receiving component 606 may be arranged to receive product information from one or more goods or services that a user wishes to purchase. The product information receiving component 606 may also be arranged to compile and combine the product information.

The transaction information transmitting component 608 may be arranged to transmit the transaction information to a server device, such as the merchant server 110 or the application server 102 of FIG. 1. The transaction completion message receiving component 610 may be arranged to receive a transaction completion message from the server device. The transaction completion message may indicate whether the transaction was successful or unsuccessful.

The display component 612 may be arranged to display details of the transaction completion message to an operator. The printing component 614 may be arranged to print the transaction completion message.

### III. Example Operations

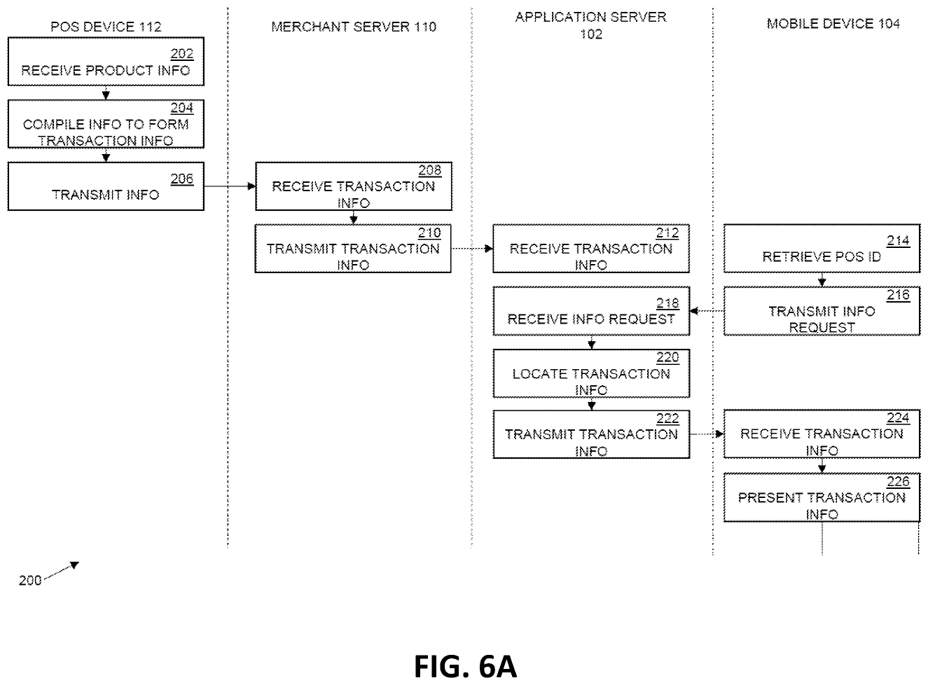

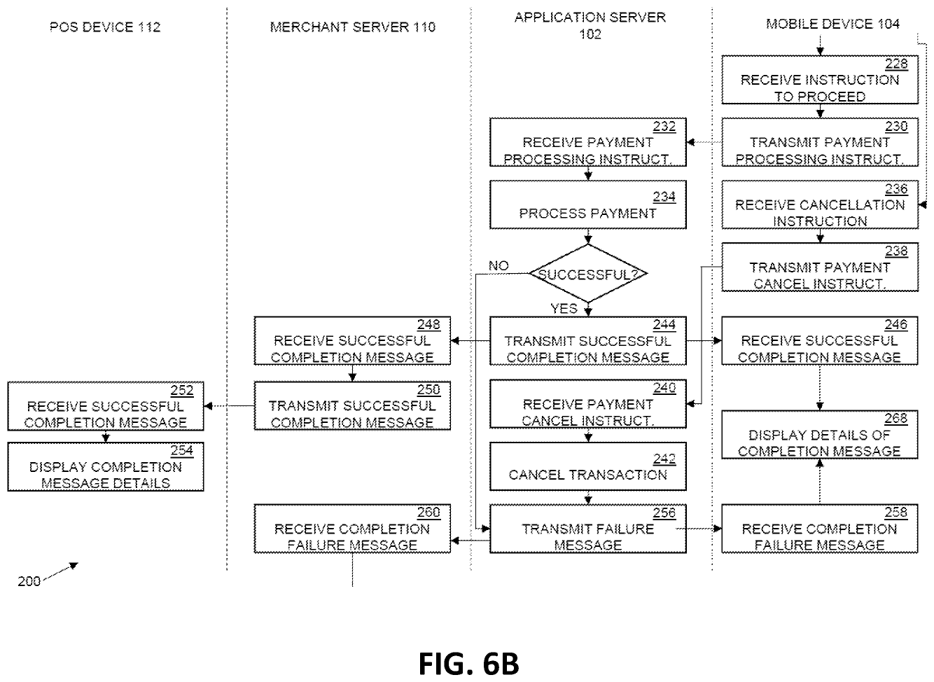

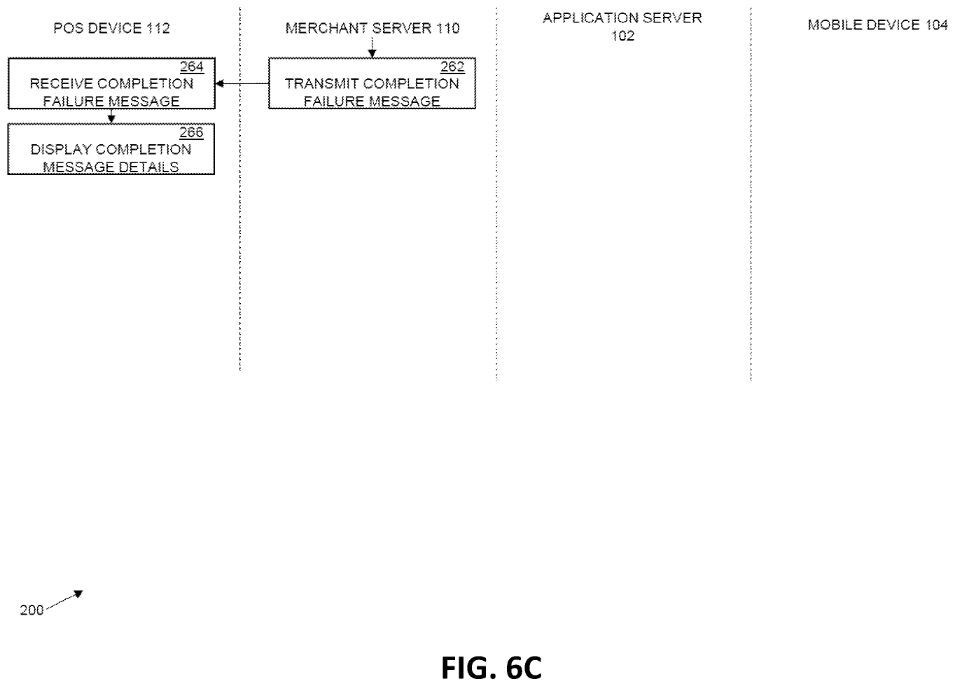

In line with the discussion above, the system 100 can be used for processing payment at a location, such as a POS. FIGS. 6A-6C form a swim-lane flow diagram 200 that illustrates an example method for processing payment. The example method can be performed by the POS device 112, the merchant server 110, the application server 102, and the mobile device 104. Operations of the method performed on the mobile device 104 may be performed by an application installed thereon. Respective swim-lanes indicate respective operations, functions, steps, decisions or processes that can be performed by the respective devices. The operations are shown within blocks 202 through 266. A description of those blocks now follows.

In the example method, the location at which the transaction is to be completed is described as a POS of one of a multiple POSs at the supermarket. While the example of a supermarket is used, it should be noted that the merchant may be from any industry that provides goods and/or services to a user. A spa, for example, may sell services and goods to a user, while a gardening service might only provide services to a user.

Referring to FIG. 1 and FIGS. 6A-6C, the example method can, for example, be carried out when the user 106 has collected a plurality of products from the shelves of the supermarket and arrives at the POS to pay therefor prior to leaving the store. The products may also be referred to as goods. The example method can also be carried out to purchase services. The operator 116 at the POS can ring up the items by scanning a barcode provided on the products themselves using a scanner of the POS device itself or a scanner associated with the POS device. Products at a merchant are sometimes provided with barcodes which define an identifier of the product. The scanner can scan the barcode to extract the encrypted information. An identification number can also be printed adjacent the barcode. When a product does not or cannot successfully scan, the cashier may manually enter the number via an input device, such as user interface associated with the POS device. The POS device 112 can then retrieve product information, including a price for the item, from a central POS database (not shown) associated with the specific merchant. Retrieving product information from an identifier of the product can involve providing the identification number to the central POS database for identification of the product and receiving product information back in return.

At block 202, when products that the user 106 wishes to purchase are rung up, the POS device can receive the product information for the products. Afterwards, the user may indicate to the operator 116 that they wish to pay for the products using the mobile device 104. For example, the user may indicate that they wish to pay for the products using the application installed on the mobile device 104. At block 204, the POS device can compile and combine the product information to form transaction information. The transaction information can include a unique identifier of the POS, the name of the merchant at which the transaction is occurring, the name of the cashier operating the POS, an itemised list of the goods or services that are to be paid for, including a description of each of the goods or services, a price for each product, a total amount payable, and a total amount of value added tax (VAT) that is to be paid on the entire transaction. The transaction information may further include details of a promotion that is applied, and a savings amount applicable to the transaction or to any of the goods or services. The cashier can initiate payment for the products, and, at block 206, the POS device can transmits the transaction information to the merchant server 110 over the communication network 114.

At block 208, the merchant server 110 can receive the transaction information. At block 210, the merchant server 110 can transmit the transaction information to the application server 102 over the communication network 108. At block 212, the application server 102 can receive the transaction information. The transaction information can include a first location identifier, such as an identifier of the POS.

At block 214, the user 106 may instruct the mobile device 104 to retrieve the unique identifier of the POS. For instance, the unique identifier can be encoded in a QR code printed on a sign that is located at the POS. Retrieving the POS identifier can involve capturing the QR code using a scanner, such as a camera, of the mobile device 104, and decrypting the QR code using the application installed on the mobile device 104 so as to reveal the first location identifier. At block 216, the mobile device 104 can transmit a request for information relating to the transaction to the application server 102. At block 218, the application server 102 can receive the request. The request for information can includes a second location identifier, such as the POS identifier. In addition, the request for information can include a unique identifier of the mobile device 104, such as a Mobile Station International Subscriber Directory Number (MSISDN) of the mobile device 104 that uniquely identifies the mobile device 104. The unique identifier may form part of other communications between the mobile device 104 and the application server 102 as well.

At block 220, the application server 102 can locate transaction information relating to and associated with the request for information by determining an association between the first location identifier and the second location identifier. For example, the application server 102 can match the second location identifier received with the request for information relating to a transaction with the first location identifier received as part of the transaction information received from the merchant server 110. At block 222, the application server 102 can transmit at least a part of the transaction information to the mobile device 104 of the user.

At block 224, the mobile device can receive the part of the transaction information. At block 226, the mobile device can present the part of the transaction information to the user in an appropriate format. The part of the transaction information can be presented in a form similar to a receipt generally provided at a POS after payment, so that the user may view the individual items, the amounts payable for each of the items, the total amount due, the value added tax, and the like, as required. The name of the merchant and cashier, and an identifier of the POS may also be presented to the user, which can assist a user in confirming that the correct transaction information has been provided. Notably, in existing methods where the user has to enter a payment amount themselves, it is not possible for the user to review the transaction information on their mobile device. Further, because the amount due can be included in the transaction information, the cashier and the user might not need to check the amount due. The mobile device 104 can include a touch-sensitive display on which a graphic user interface is provided and with which the user may interact.

The user can interact with the mobile device 104 via an appropriate selectable button or the like appearing on the touch-sensitive display. For instance, the user can select a button to provide user input as to how to proceed with the transaction. More than one button may be provided. For example, a “Proceed” button and a “Cancel” button may be provided on the display. Selection of a button can allow the method to proceed. If a user wishes to proceed with the transaction after the transaction information has been displayed, the user can select the “Proceed” button.

Moving to FIG. 6B, at block 228, the mobile device 104 can receive the user input instruction to proceed with the transaction. At block 230, the mobile device 104 can transmit the instruction to the application server 102 to process payment for the transaction.

As mentioned above with reference to FIG. 1, payment credentials of the user can have previously been provided to the application server 102 for appropriate storage. Therefore, at block 232, the application server 102 can receive the payment processing instruction and, at block 234, the application server 102 can process the payment. Processing the payment can involve retrieving payment credentials from the database 122. An identifier of the mobile device 104 received with the request for such information may be used to identify the payment credentials of the user at the database 122. Payment processing with the user's payment credentials may then take place in any appropriate manner known in the art.

If the user selects the “Cancel” button, at block 236, the mobile device 104 can receive a payment cancellation instruction. At block 238, the mobile device 104 can transmit a payment cancellation instruction to the application server 102. At block 240, the application server 102 can receive the payment cancellation instruction and, at block 242, the application server can cancel the transaction.

If the application server 102 successfully processes payment, at block 244, the application server can transmit a transaction successfully completed message to the merchant server 110 and to the mobile device 104. At block 246, the mobile device 104 can receive the transaction successfully completed message. At block 248, the merchant server 110 can receive the transaction successfully completed message. Further, at block 250, the merchant server 110 can transmit details of the transaction successfully completed message to the POS device 112 as part of a transaction completed message. At block 252, the POS device 112 can receive the transaction completed message and, at block 254, the POS device 112 can display details of the transaction completed message to a cashier operating the POS. The POS device 112 can display the transaction completed message on a display associated with the POS device 112, or the POS device 112 can print the transaction completed message on a receipt using a printer associated with the POS device 112.

If the transaction is unsuccessful, due to the transaction being cancelled or for another reason, at block 256, the application server 102 can transmit a transaction completion failure message to the merchant server 110 and to the mobile device 104. It should be noted that there may be various reasons for a transaction to fail. Communications failure examples include a timeout of communications, a complete failure in communication, network protocol problems, network anomalies, or the like. Failure of a user to timeously respond with appropriate input to proceed or cancel a transaction may also lead to a timeout. This may by initiated by the application operating on the mobile device. Financial institution-related failures such as insufficient user funds, incorrect payment credentials, daily transaction or spend limit reached, and the like may also cause a transaction to fail. Multiple examples of such reasons are known in the art. It is envisaged that the completion failure message that may be transmitted by the application server may include information specifying the reasons for the failure, whether in the form of an error code or an explanation. This may assist a user and/or a merchant to identify the reason for the failure, which may in turn assist in rectifying the error (by, for example, choosing different payment credentials) or eliminating the error (by, for example, using a different payment method) so that the transaction can be successfully completed.

At block 258, the mobile device 104 can receive the transaction completion failure message. At block 260, the merchant server 110 can receive the transaction completion failure message.

Moving to FIG. 6C, at block 262, the merchant server 110 can transmit details of the transaction completion failure message to the POS device 112 as part of a transaction competed message. At block 264, the POS device 266 can display details of the transaction completed message to a cashier operating the POS. The POS device 112 can display the transaction completed message on a display associated with the POS device 112, or the POS device 112 can print the transaction completed message on a receipt using a printer associated with the POS device 112. The POS device 112 may be configured such that the printer prints a receipt with appropriate information regardless of whether the transaction was ultimately successful or unsuccessful. The transaction may be considered complete at this stage and if it was unsuccessful, for whatever reason, and the operator and user want to retry using the same payment method, the payment process can be restarted.

At block 268, shown in FIG. 6B, the mobile device 104 can display details of the completion message received at block 246 or the completion message received at block 258. In this manner, the user of the mobile device 104 can be informed of the success, or not, of the payment process.

After successful payment, a user may take the purchased products out of the supermarket as is normally expected. If payment is not successful, the cashier may request retrying payment, either using the same method described above or another method available at the POS.

In some embodiments, a user may sign up for use of the present payment system and method at about the same time as conducting their first transaction therewith. In such an event, the user may first provide the details used to register for the system, possibly a user name, password, contact details and the like as well as their payment credentials. When this information has been successfully stored and a user account created using such details, the present method may commence. At that stage, the user device may be considered “registered for use of the method”, and the application server may be able to use the user's payment credentials to process payment for a transaction. The application server may allow a user to create an account without immediately providing payment credentials. In such an event, payment credentials may be requested from the user by the application operating on the mobile device of the user when the user attempts to use the present methods and systems. The user may provide such credentials to their mobile device, which may transmit it to the application system for use. These payment credentials may then be used to process a current transaction, and may be associated with the mobile device and stored in an appropriate database for future use.

In some embodiments, the user may associate multiple sets of payment credentials with a single mobile device. These credentials may relate to different accounts at a single financial institution, at multiple institutions, or may relate to different forms and currencies usable for payment. Then, the method may include the steps of the mobile device providing the user with a selection of payment credentials which may be used to process payment, and receiving user input indicating which of the payment credentials should be used to process payment. The selection of payment credentials may be retrieved by the application server and transmitted to the mobile device before being presented to the user. It will be apparent that the method may then also include the step of the mobile device transmitting details of the selected payment credentials to be used to process payment to the application server. Details of the payment credentials to be used may form part of the transaction processing instruction. Payment credentials to be used for payment may be stored on the database described above, or may also be provided to the merchant during first-time use thereof. If already stored on the database, only an identifier of the payment credentials may be provided to the application server after selection thereof by the user.

It will be apparent that a user may be provided with the option of removing stored payment credentials from the database and the option of closing their user account with the application server at a time of their choosing. Similarly, a user may be allowed the opportunity to update and edit their user account or payment credentials.

In some embodiments, only a single transaction per unique POS may be possible at a time, unless a method is employed to distinguish between more than one transaction per unique POS. A pending transaction may be identified by the fact that transaction information, which includes a location identifier, has been received from a merchant server, without a matching location identifier having been received from a mobile device with a request for transaction information. Should such a matching location identifier not be received with a request for transaction information, the pending transaction may time out and may automatically be cancelled. The merchant server may be informed of this fact, and may notify the POS device of this as well. If the timeout has not been reached but transaction information is received from a merchant server for a POS with a pending transaction, the pending transaction may also be automatically cancelled.

If a merchant only has a single POS device, a merchant identifier could also be used as the location identifier. If a merchant has multiple POS devices, the merchant's identifier could be a relatively long number, with a shorter identifier, possibly a two-digit number, being used to identify a POS. Then, the uniqueness of the location identifier could be as a result of the combination of the merchant identifier and the POS identifier. The identifier of the POS could also include an identifier of the merchant as part of its structure.

Communication between the application server and the mobile device using the application installed on the mobile device may be done during a single session, and over an encrypted communications session established therebetween. Different types of communication channels may be used as well, for example an unstructured supplementary service data communications channel, the Internet, or the like.

The transaction information received by the application server might not have all been provided by the POS device. As an example, the merchant server may modify the transaction information prior to transmitting it to the application server by including details of the merchant itself, by applying promotions, by including the name of the cashier, by including an identifier of the POS or the POS device, and the like. The merchant server may identify the POS and associated device and cashier based on an identifier the POS device provides to the merchant server, or the merchant server may use a unique network address of the POS device to identify the correct information to add to the transaction information.

The application server may also modify the transaction information prior to transmitting the transaction information to the mobile device. The application server may have access to loyalty card details of a user that are associated with a user profile of the user. After determining an association between the location identifier received from the merchant server and the location identifier received from the mobile device, the application server may identify the merchant, recognize that the user account associated with the mobile device from which the request has been received has a loyalty card with the specific merchant, and may then apply discounts, savings, or the like to that account. If use of the loyalty card provides the user with loyalty points or the like, the application server may automatically transmit details of the transaction to the merchant server with a transaction successfully completed message for further allocation and processing thereof.

In addition, an application server operator may have a specific agreement with the merchant that a user receives a promotion or savings if the user uses the present system and method to process payment at that merchant. If so, the application server may automatically apply that promotion or saving and update the transaction information accordingly before processing payment. As an example, use of the present systems and methods may allow a “buy 3 and only pay for 2” promotion, which may induce a user to use the present systems and methods. If the transaction information indicates that three qualifying items form part of the user's intended purchase, the application server may update the transaction information such that the user is informed of the promotion, their savings as a result thereof, and may be asked to process payment for an appropriately reduced amount. Then, the user may process payment as described above, and the application server may simply inform the merchant server that payment has been successfully processed. The reduction may then be reconciled between the merchant and the application server operator at a later stage. Alternatively, the transaction successfully completed message transmitted to the merchant server may include details of the promotion and savings applied.

As another example, a user may receive a gift from the merchant via the cashier if the application server transmits a message to the cashier to do so, possibly as a result of a total amount spent using the present systems and methods, potentially in a predetermined time period, that the number of uses of the present systems and methods has reached a predetermined number, or the like. Other examples of savings and promotions may also be incorporated in the present systems and methods.

The application server may integrate with discount services which offer, as an example, two-for-one specials at specific merchants. If so, the application server could automatically apply a discount offered by such service provider, without the need for the user to provide details of the discount service offering to the merchant, and without the need to manually adjust the transaction information. The application server may communicate with a third party who offers such discount services and with which the user also has an account, to reconcile such offered discounts with them, at an appropriate time.

A user may be provided, on their mobile device, with the option to save on the mobile device the transaction information that the mobile device receives from the application server. The saved information may then serve as a proof of purchase in the event the user wishes to return an item, for record and bookkeeping purposes, and for tax purposes. The information may be saved on a local storage medium associated with the mobile device, or may be transmitted to another device for storage, for example to a server associated with an email account of the user, or the like.

As the payment credentials stored in the database may be uniquely associated with a specific user's mobile device, it will be apparent that the loss or replacement of a user's mobile device may cause the disassociation of the payment credentials therewith. This may prevent unwanted use of the user's payment credentials by a person in possession of the user's old, stolen or lost mobile device. It may be expected of a user to inform the application server if their mobile device has been stolen or lost so that future transactions attempted with their mobile device may be blocked.

In the example method described with reference to FIGS. 6A-6C, the location identifier is captured from a QR code, with the application operating on the mobile device being adapted to decrypt the QR code to extract the location identifier. However, many other technologies may be used to provide the location identifier to a user's mobile device. As an example, an RFID tag or NFC tag may be provided, and the user's mobile device may include an appropriate RFID or NFC scanner or reader to scan such a tag. The application may again be configured to extract the location identifier from the scanned tag, and the method may operate further in the same manner as described above with reference to the figures.

In some embodiments, a user may be provided with the option to add a tip, or gratuity, to a purchase before instructing the application server to process payment. The user might not be allowed to lower the total amount payable, but may be allowed to enter a tip amount. Convenient selectable percentage signs may be provided to assist a user in tipping, for example, 10%, 12% or 15%. The user may then select the desired percentage, and the total amount payable may be automatically increased. The payment processing instruction may then include details of the tip to be added to the total payable amount, and payment may then be processed for the new total amount. The user may also be able to manually enter an arbitrary amount as a tip.

Any of the blocks of a flow diagram or a component in a block diagram may be provided by hardware or by software associated with the specific electronic device, whether the POS device, user's mobile device, or any server. These electronic devices may be embodied by a personal computer, laptop computer, personal digital assistant, smartphone, feature phone, satellite phone, server computer, phablet, tablet, wearable computer, or the like. Appropriate components may form part of such device for the operation of the required method on that device. Further, the electronic devices may be configured to communicate wirelessly or over a wired communications network. The various components forming part of each electronic device may be configured to communicate with each other via an appropriate communications interface, while an appropriate external communications interface may facilitate communication with other electronic devices, whether forming part of the present systems or not.

Notably, the feature of locating transaction information relating to the request for information by determining an association between the first location identifier and the second location identifier, and then providing at least part of the transaction information to the mobile device so that the mobile device can review the transaction information and decide whether to proceed is an improvement to existing payment processing technology. As noted above, traditionally, the user enters a payment amount manually on a mobile device, which is prone to user error. Alternatively, a POS device can generate a dynamic QR code that includes details of a transaction and display the dynamic QR code to the user. The use of dynamic QR codes, however, can be wasteful or create significant costs for a merchant. The systems and methods described herein allow a user to obtain details of products that are to be purchased, without the provision of unique QR codes for each transaction, and prior to instructing the application server to process payment. This can allow the user to check transaction information before completing a transaction. Consequently, the systems and methods described herein are a technological improvement to payment processing.

In addition, the user may be allowed to save the transaction information for future reference. A user may have their payment credentials stored at a database associate with the application server, which may assist a user in transacting as they do not need to provide it at every purchasing instance. However, the user may still be allowed to provide new credentials when required.

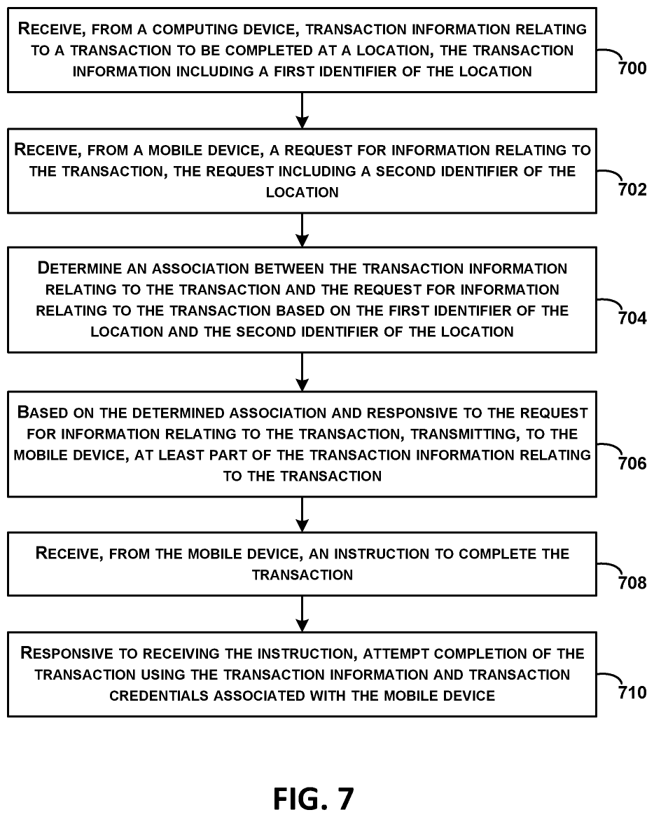

FIG. 7 depicts a flow chart showing a set of operations that can, for example, be carried out using an application server, such as the application server 102 of FIG. 1. Several of the operations described in connection with FIG. 7 parallel operations described in connection with FIGS. 6A-6C. As such, variations of the operations described in connection with FIGS. 6A-6C are likewise applicable to the operations described in connection with FIG. 7. However, for the sake of brevity, these variations are not repeated.

Initially, block 700 includes receiving, from a computing device, transaction information relating to a transaction to be completed at a location, the transaction information including a first identifier of the location. In some embodiments, the computing device is located at the location, and receiving the transaction information includes receiving the transaction information from the computing device by way of a communication network. In some embodiments, the computing device is a server device in data communication with a POS device located at the location, and receiving the transaction information includes receiving the transaction information from the server device by way of a communication network.

In some embodiments, the transaction information includes a list of goods or services, a total amount due, a savings amount applicable to the transaction, a promotion application to the transaction, and/or a tax payable on the transaction.

Block 702 includes receiving, from a mobile device, a request for information relating to the transaction, the request including a second identifier of the location. In some embodiments, the second identifier of the location is retrieved by the mobile device by capturing an encrypted version of the second identifier of the location and decrypting the encrypted version. The encrypted version can be captured from a barcode, such as a QR code. Alternatively, the encrypted version can be captured from an RFID tag, such as an NFC tag.

Block 704 includes determining an association between the transaction information relating to the transaction and the request for information relating to the transaction based on the first identifier of the location and the second identifier of the location. For example, the first identifier of the location could be matched to the second identifier of the location.

Block 706 includes, based on the determined association and responsive to the request for information relating to the transaction, transmitting, to the mobile device, at least part of the transaction information relating to the transaction.

Block 708 includes receiving, from the mobile device, an instruction to complete the transaction.

Block 710 includes, responsive to receiving the transaction, attempting completion of the transaction using the transaction information and transaction credentials associated with the mobile device.

In some embodiments, the first identifier of the location and the second identifier of the location are static identifiers of the location. For instance, the first identifier and the second identifier might be the same for multiple transactions conducted at a location.

Additional blocks not illustrated in FIG. 7 can include (i) determining, by the application server, that a promotion applies to the transaction and (ii) responsive to determining that the promotion applies to the transaction, modifying, by the application server, the transaction information to include the promotion.

Further, additional blocks not illustrated in FIG. 7 can include (i) determining, by the application server, whether the transaction was successful or unsuccessful and (ii) based on the determining whether the transaction was successful or unsuccessful, transmitting, by the application server to the computing device or the mobile device, a transaction message indicating whether the transaction was successful or unsuccessful.

Still further, additional blocks not illustrated in FIG. 7 can include receiving, by the application server from the mobile device, the transaction credentials. Alternatively, additional blocks not illustrated in FIG. 7 can include retrieving, by the application server from a database, the transaction credentials.

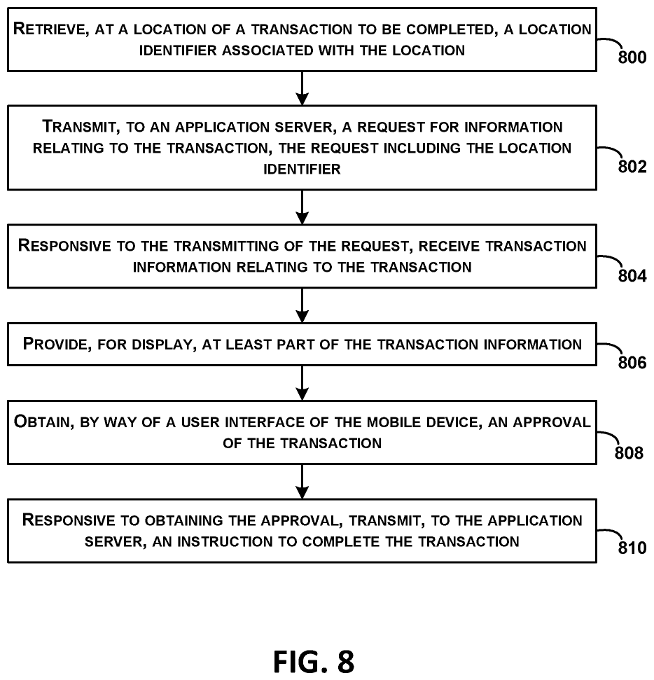

FIG. 8 depicts a flow chart showing a set of operations that can, for example, be carried out using a mobile device, such as the mobile device 104 of FIG. 1. Several of the operations described in connection with FIG. 8 parallel operations described in connection with FIGS. 6A-6C. As such, variations of the operations described in connection with FIGS. 6A-6C are likewise applicable to the operations described in connection with FIG. 8. However, for the sake of brevity, these variations are not repeated.

Initially, block 800 includes retrieving, at a location of a transaction to be completed, a location identifier associated with the location. In some embodiments, retrieving the location identifier includes capturing an encrypted version of the location identifier using a scanner associated with the mobile device and decrypting the encrypted version so as to reveal the location identifier. The encrypted version can be captured from a barcode, such as a QR code. Alternatively, the encrypted version can be captured from an RFID tag, such as an NFC tag. Further, in some embodiments, the location identifier can be a static identifier associated with the location.

Block 802 includes transmitting, to an application server, a request for information relating to the transaction, the request including the location identifier.

Block 804 includes, responsive to the transmitting of the request, receiving transaction information relating to the transaction.

Block 806 includes, providing, for display, at least part of the transaction information. In some embodiments, the at least part of the transaction information includes a list of goods or services, a total amount due, a savings amount applicable to the transaction, a promotion application to the transaction, and/or a tax payable on the transaction.

Block 808 includes obtaining, by way of a user interface of the mobile device, an approval of the transaction.

Block 810 includes, responsive to obtaining the approval, transmitting, to the application server, an instruction to complete the transaction.

In some embodiments, obtaining the approval includes obtaining, by way of the user interface, transaction credentials for completing the transaction, and the instruction to complete the transaction identifies the transaction credentials.

Additional blocks not illustrated in FIG. 8 can include (i) receiving, by the mobile device from the application server, a transaction message indicating whether the transaction was successful or unsuccessful and (ii) providing, by the mobile device for display, an indication of whether the transaction was successful or unsuccessful.

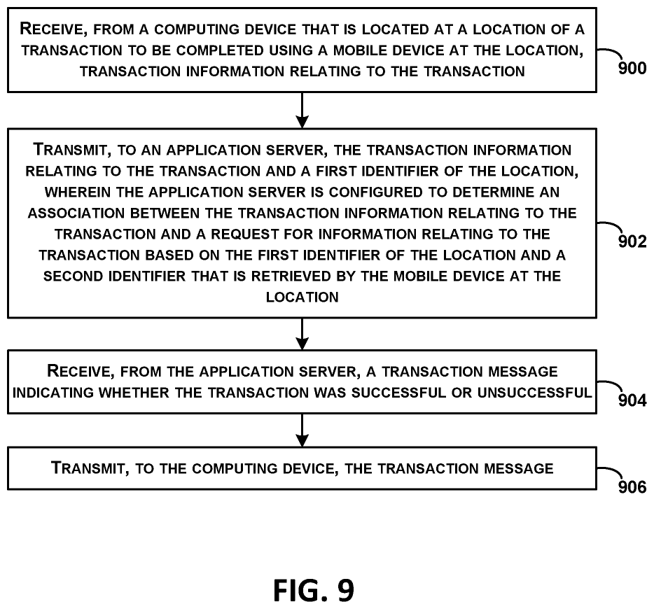

FIG. 9 depicts a flow chart showing a set of operations that can, for example, be carried out using a server device, such as the merchant server 110 of FIG. 1. Several of the operations described in connection with FIG. 9 parallel operations described in connection with FIGS. 6A-6C. As such, variations of the operations described in connection with FIGS. 6A-6C are likewise applicable to the operations described in connection with FIG. 9. However, for the sake of brevity, these variations are not repeated.

Initially, block 900 includes receiving, from a computing device that is located at a location of a transaction to be completed using a mobile device at the location, transaction information relating to the transaction. In some embodiments, the transaction information includes a list of goods or services, a total amount due, a savings amount applicable to the transaction, a promotion application to the transaction, and/or a tax payable on the transaction.

Block 902 includes transmitting, to an application server, the transaction information relating to the transaction and a first identifier of the location. The application server is configured to determine an association between the transaction information relating to the transaction and a request for information relating to the transaction based on the first identifier of the location and a second identifier that is retrieved by the mobile device at the location. In some embodiments, the first identifier of the location and the second identifier of the location are static identifiers of the location.

Block 904 includes receiving, from the application server, a transaction message indicating whether the transaction was successful or unsuccessful.

Block 906 includes transmitting, to the computing device, the transaction message.

### IV. Additional Example Embodiments

The following clauses are offered as further description of the disclosed embodiments.

(1) A computer-implemented method comprising:

receiving, by an application server from a computing device, transaction information relating to a transaction to be completed at a location, the transaction information including a first identifier of the location;

receiving, by the application server from a mobile device, a request for information relating to the transaction, the request including a second identifier of the location;

determining, by the application server, an association between the transaction information relating to the transaction and the request for information relating to the transaction based on the first identifier of the location and the second identifier of the location;

based on the determined association and responsive to the request for information relating to the transaction, transmitting, by the application server to the mobile device, at least part of the transaction information relating to the transaction;

receiving, by the application server from the mobile device, an instruction to complete the transaction; and

responsive to receiving the instruction, attempting, by the application server, completion of the transaction using the transaction information and transaction credentials associated with the mobile device.

(2) The computer-implemented method of clause (1), wherein the second identifier of the location is retrieved by the mobile device by capturing an encrypted version of the second identifier of the location and decrypting the encrypted version.

(3) The computer-implemented method of clause (2), wherein the encrypted version is captured from a barcode.

(4) The computer-implemented method of clause (3), wherein the barcode is a quick response (QR) code.

(5) The computer-implemented method of clause (2), wherein the encrypted version is captured from a radio frequency identification (RFID) tag.

(6) The computer-implemented method of clause (5), wherein the RFID tag is a near field communication (NFC) tag.

(7) The computer-implemented method of any of clauses (1)-(6), wherein the first identifier of the location and the second identifier of the location are static identifiers of the location.

(8) The computer-implemented method of any of clauses (1)-(7), wherein the computing device is located at the location, and wherein receiving the transaction information relating to the transaction comprises receiving the transaction information from the computing device by way of a communication network.

(9) The computer-implemented method of any of clauses (1)-(7), wherein the computing device is a server device in data communication with a point-of-sale device located at the location, and wherein receiving the transaction information relating to the transaction comprises receiving the transaction information from the server device by way of a communication network.

(10) The computer-implemented method of any of clauses (1)-(9), further comprising:

determining, by the application server, that a promotion applies to the transaction; and

responsive to determining that the promotion applies to the transaction, modifying, by the application server, the transaction information to include the promotion.

(11) The computer-implemented method of any of clauses (1)-(10), further comprising:

determining, by the application server, whether the transaction was successful or unsuccessful; and

based on the determining whether the transaction was successful or unsuccessful, transmitting, by the application server to the computing device or the mobile device, a transaction message indicating whether the transaction was successful or unsuccessful.

(12) The computer-implemented method of any of clauses (1)-(11), further comprising receiving, by the application server from the mobile device, the transaction credentials.

(13) The computer-implemented method of any of clauses (1)-(11), further comprising retrieving, by the application server from a database, the transaction credentials.

(14) The computer-implemented method of any of clauses (1)-(13), wherein the transaction information comprises a list of goods or services.

(15) The computer-implemented method of any of clauses (1)-(14), wherein the transaction information comprises a total amount due.

(16) The computer-implemented method of any of clauses (1)-(15), wherein the transaction information comprises a savings amount applicable to the transaction.

(17) The computer-implemented method of any of clauses (1)-(16), wherein the transaction information comprises a promotion applicable to the transaction.

(18) The computer-implemented method of any of clauses (1)-(17), wherein the transaction information comprises tax payable on the transaction.

(19) An article of manufacture including a non-transitory computer-readable medium, having stored thereon program instructions that, upon execution by a processor, cause an application server to perform the operations of any of clauses (1)-(18).

(20) An application server comprising:

a processor;

a memory component; and

program instructions, stored in the memory, that upon execution by the processor, cause the application server to perform the operations of any of clauses (1)-(18).

(21) A system comprising means for performing the operations of any of clauses (1)-(18).

(22) A computer-implemented method comprising:

retrieving, by a mobile device at a location of a transaction to be completed, a location identifier associated with the location;

transmitting, by the mobile device to an application server, a request for information relating to the transaction, the request including the location identifier;

responsive to the transmitting of the request, receiving, by the mobile device, transaction information relating to the transaction;

providing, by the mobile device for display, at least part of the transaction information;

obtaining, by the mobile device by way of a user interface of the mobile device, an approval of the transaction; and

responsive to obtaining the approval, transmitting, by the mobile device to the application server, an instruction to complete the transaction.

(23) The computer-implemented method of clause (22), wherein retrieving the location identifier comprises:

capturing an encrypted version of the location identifier using a scanner associated with the mobile device; and

decrypting the encrypted version so as to reveal the location identifier.

(24) The computer-implemented method of clause (23), wherein the encrypted version is captured from a barcode.

(25) The computer-implemented method of clause (24), wherein the barcode is a quick response (QR) code.

(26) The computer-implemented method of clause (23), wherein the encrypted version is captured from a radio frequency identification (RFID) tag.

(27) The computer-implemented method of clause (26), wherein the RFID tag is a near field communication (NFC) tag.

(28) The computer-implemented method of any of clauses (22)-(27), wherein the location identifier associated with the location is a static identifier associated with the location.

(29) The computer-implemented method of any of clauses (22)-(28):

wherein obtaining the approval comprises obtaining, by the mobile device by way of the user interface, transaction credentials for completing the transaction, and

wherein the instruction to complete the transaction identifies the transaction credentials.

(30) The computer-implemented method of any of clauses (22)-(29), further comprising:

receiving, by the mobile device from the application server, a transaction message indicating whether the transaction was successful or unsuccessful; and

providing, by the mobile device for display, an indication of whether the transaction was successful or unsuccessful.

(31) The computer-implemented method of any of clauses (22)-(30), wherein the at least part of the transaction information comprises a list of goods or services.

(32) The computer-implemented method of any of clauses (22)-(31), wherein the at least part of the transaction information comprises a total amount due.

(33) The computer-implemented method of any of clauses (22)-(32), wherein the at least part of the transaction information comprises a savings amount applicable to the transaction.

(34) The computer-implemented method of any of clauses (22)-(33), wherein the at least part of the transaction information comprises a promotion applicable to the transaction.

(35) The computer-implemented method of any of clauses (22)-(34), wherein the at least part of the transaction information comprises tax payable on the transaction.

(36) An article of manufacture including a non-transitory computer-readable medium, having stored thereon program instructions that, upon execution by a processor, cause a mobile device to perform the operations of any of clauses (22)-(35).

(37) A mobile device comprising:

a processor;

a memory component; and

program instructions, stored in the memory, that upon execution by the processor, cause the mobile device to perform the operations of any of clauses (22)-(35).

(38) A system comprising means for performing the operations of any of clauses (22)-(35).

(39) A computer-implemented method comprising:

receiving, by a server device from a computing device that is located at a location of a transaction to be completed using a mobile device at the location, transaction information relating to the transaction;

transmitting, by the server device to an application server, the transaction information relating to the transaction and a first identifier of the location, wherein the application server is configured to determine an association between the transaction information relating to the transaction and a request for information relating to the transaction based on the first identifier of the location and a second identifier of the location that is retrieved by the mobile device at the location;

receiving, by the server device from the application server, a transaction message indicating whether the transaction was successful or unsuccessful; and

transmitting, by the server device to the computing device, the transaction message.

(40) The computer-implemented method of clause (39), wherein the first identifier of the location and the second identifier of the location are static identifiers of the location.

(41) The computer-implemented method of clause (39) or clause (40), wherein the transaction information comprises a list of goods or services.

(42) The computer-implemented method of any of clauses (39)-(41), wherein the transaction information comprises a total amount due.

(43) The computer-implemented method of any of clauses (39)-(42), wherein the transaction information comprises a savings amount applicable to the transaction.

(44) The computer-implemented method of any of clauses (39)-(43), wherein the transaction information comprises a promotion applicable to the transaction.

(45) The computer-implemented method of any of clauses (39)-(44), wherein the transaction information comprises tax payable on the transaction.

(46) An article of manufacture including a non-transitory computer-readable medium, having stored thereon program instructions that, upon execution by a processor, cause a network server to perform the operations of any of clauses (39)-(45).

(47) A server device comprising:

a processor;

a memory component; and

program instructions, stored in the memory, that upon execution by the processor, cause the server device to perform the operations of any of clauses (39)-(45).

(48) A system comprising means for performing the operations of any of clauses (39)-(45).

### V. Conclusion

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the disclosure can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

1. A computer-implemented method comprising:
receiving, by an application server from a computing device, transaction information relating to a transaction to be completed at a location, the transaction information including a first identifier of the location;
receiving, by the application server from a mobile device, a request for information relating to the transaction, the request including a second identifier of the location;
determining, by the application server, an association between the transaction information relating to the transaction and the request for information relating to the transaction based on the first identifier of the location and the second identifier of the location;
based on the determined association and responsive to the request for information relating to the transaction, transmitting, by the application server to the mobile device, at least part of the transaction information relating to the transaction;
receiving, by the application server from the mobile device, an instruction to complete the transaction; and
responsive to receiving the instruction, attempting, by the application server, completion of the transaction using the transaction information and transaction credentials associated with the mobile device.

2. The computer-implemented method of claim 1, wherein the second identifier of the location is retrieved by the mobile device by capturing an encrypted version of the second identifier of the location and decrypting the encrypted version.

3. The computer-implemented method of claim 2, wherein the encrypted version is captured from a barcode.

4. The computer-implemented method of claim 3, wherein the barcode is a quick-response (QR) code.

5. The computer-implemented method of claim 2, wherein the encrypted version is captured from a radio frequency identification (RFID) tag.

6. The computer-implemented method of claim 5, wherein the RFID tag is a near-field communication (NFC) tag.

7. The computer-implemented method of claim 1, wherein the first identifier of the location and the second identifier of the location are static identifiers of the location.

8. The computer-implemented method of claim 1, wherein the computing device is located at the location, and wherein receiving the transaction information relating to the transaction comprises receiving the transaction information from the computing device by way of a communication network.

9. The computer-implemented method of claim 1, wherein the computing device is a server device in data communication with a point-of-sale device located at the location, and wherein receiving the transaction information relating to the transaction comprises receiving the transaction information from the server device by way of a communication network.

10. The computer-implemented method of claim 1, further comprising:
determining, by the application server, that a promotion applies to the transaction; and
responsive to determining that the promotion applies to the transaction, modifying, by the application server, the transaction information to include the promotion.

11. The computer-implemented method of claim 1, further comprising:
determining, by the application server, whether the transaction was successful or unsuccessful; and
based on the determining whether the transaction was successful or unsuccessful, transmitting, by the application server to the computing device or the mobile device, a transaction message indicating whether the transaction was successful or unsuccessful.

12. The computer-implemented method of claim 1, further comprising receiving, by the application server from the mobile device, the transaction credentials.

13. The computer-implemented method of claim 1 further comprising retrieving, by the application server from a database, the transaction credentials.

14. The computer-implemented method of claim 1, wherein the transaction information comprises one or more of a list of goods or services, a total amount due, a savings amount applicable to the transaction, a promotion applicable to the transaction and tax payable on the transaction.

15. An article of manufacture including a non-transitory computer-readable medium, having stored thereon program instructions that, upon execution by a processor, cause an application server to perform operations comprising:
receiving, from a computing device, transaction information relating to a transaction to be completed at a location, the transaction information including a first identifier of the location;
receiving, from a mobile device, a request for information relating to the transaction, the request including a second identifier of the location;
determining an association between the transaction information relating to the transaction and the request for information relating to the transaction based on the first identifier of the location and the second identifier of the location;
based on the determined association and responsive to the request for information relating to the transaction, transmitting, to the mobile device, at least part of the transaction information relating to the transaction;
receiving, from the mobile device, an instruction to complete the transaction; and
responsive to receiving the instruction, attempting completion of the transaction using the transaction information and transaction credentials associated with the mobile device.

16. An application server comprising:
a processor;
a memory component; and
program instructions, stored in the memory, that upon execution by the processor, cause the application server to perform operations comprising:
receiving, from a computing device, transaction information relating to a transaction to be completed at a location, the transaction information including a first identifier of the location,
receiving, from a mobile device, a request for information relating to the transaction, the request including a second identifier of the location,
determining an association between the transaction information relating to the transaction and the request for information relating to the transaction based on the first identifier of the location and the second identifier of the location,
based on the determined association and responsive to the request for information relating to the transaction, transmitting, to the mobile device, at least part of the transaction information relating to the transaction,
receiving, from the mobile device, an instruction to complete the transaction, and
responsive to receiving the instruction, attempting completion of the transaction using the transaction information and transaction credentials associated with the mobile device.

17-36. (canceled)
